(19) United States
(12) Patent Application Publication
(10) Pub. No.: US 2013/0297669 A1
(43) Pub. Date: Nov. 7, 2013

(54) System and Method for Integrating Fitness Information and Offering Advice

(71) Applicant: Sheng-Fang Wang, Taipei City (TW)

(72) Inventor: Sheng-Fang Wang, Taipei City (TW)

(21) Appl. No.: 13/461,920

(22) Filed: May 2, 2012

(51) Int. Cl. G06F 15/16; H04W 84/12

(52) U.S. Cl. 709/201

(57) ABSTRACT

A system for integrating fitness information includes multiple fitness equipments, multiple detecting devices, a mobile device, a cloud server and an expert system. Each fitness equipment has a fitness recorder and a local area communication interface. Each detecting device has a detecting interface and a local area communication. The mobile device has a local area communication interface, a wireless communication interface and a display interface. A method for integrating fitness information and offering advice includes the steps of: receiving fitness and physical information, transmitting the fitness and physical information, determining the fitness and physical information, and receiving the advice.

### BACKGROUND OF THE INVENTION

1. Field of the Invention

The present invention relates to a fitness information system, and more particularly to a system and a method for integrating fitness information and offering advice.

2. Description of Related Art

A conventional fitness equipment, such as an exercise bike, a stepper or a treadmill, is assembled with a medical detecting device for obtaining a body condition of a user. The user can easily realize the current condition while taking exercise. For example, a sensor is mounted on a handle of the exercise bike or pedals of the stepper for detecting physical condition of the user. A screen may be mounted on the exercise bike or the stepper for displaying visible data of the physical condition. Based on the information of the physical condition, the user can decide to take more exercise or less exercise by himself/herself.

The conventional fitness equipment may provide a memory card interface, such that the user can download and analyze the fitness information. When the user operates various fitness equipments, the user may spend a lot of time downloading the fitness information from the fitness equipments one by one and analyzing all of the fitness information. While the fitness information is being reanalyzed, the body condition may have changed. The period for analyzing may be longer than the period for exercising. Furthermore, the user can only decide the next fitness project by himself/herself after every single fitness exercise. This may take a lot of time when the user practices various fitness exercises.

To overcome the shortcomings, the present invention tends to provide a system and a method for integrating fitness information and offering advice to mitigate or obviate the aforementioned problems.

### SUMMARY OF THE INVENTION

The main objective of the invention is to provide a system for integrating fitness information that includes multiple fitness equipments, multiple detecting devices, a mobile device, a cloud server and an expert system. Each fitness equipment has a fitness recorder and a local area communication interface. The fitness recorder has a capability of storing fitness information from a user while the user operates the fitness equipment. The local area communication interface is connected to the fitness recorder and has a capability of transmitting the fitness information. Each detecting device has a detecting interface and a local area communication. The detecting interface has a capability of contacting the user and receiving physical information from the user. The local area communication interface is connected with the detecting interface and has a capability of transmitting the physical information. The mobile device has a local area communication interface, a wireless communication interface and a display interface. The local area communication interface has a capability of connecting with the local area communication interfaces of the fitness equipments and the local area communication interfaces of the detecting devices through a local area network protocol to receive the fitness information and the physical information. The wireless communication interface is connected with the local area communication of the mobile device and has a capability of transmitting the fitness information and the physical information. The display interface is connected with the wireless communication interface and has a capability of presenting advice information. The cloud server is connected with the wireless communication interface of the mobile device through a wireless communication protocol to receive the fitness information and the physical information. The expert system is connected with the cloud server, receives the fitness information and the physical information from the cloud server, determines the advice information based on the fitness information and the physical information, and transmits the advice information to the mobile device through the cloud server.

Another main objective of the invention is to provide a method for integrating fitness information and offering advice comprising:

receiving fitness and physical information: actuating a mobile device to receive the fitness information from multiple fitness equipments and receive the physical information from the multiple detecting devices through a local area communication interface;

transmitting the fitness and physical information: actuating a wireless communication interface of the mobile device to transmit the fitness and physical information to a cloud server which is connected to an expert system;

determining the fitness and physical information: utilizing the expert system to determine advice information based on the fitness and physical information and transmit the advice information to the cloud server; and

receiving the advice: actuating the wireless communication interface of the mobile device to receive the advice information from the cloud server and displaying the advice information on a display interface of the mobile device.

Other objects, advantages and novel features of the invention will become more apparent from the following detailed description when taken in conjunction with the accompanying drawings.

### BRIEF DESCRIPTION OF THE DRAWINGS

FIG. 1 is a system diagram of a system for integrating fitness information and offering advice in accordance with the present invention;

FIG. 2 is a block diagram of a fitness equipment of the system for integrating fitness information and offering advice in accordance with the present invention;

FIG. 3 is a block diagram of a detecting device of the system for integrating fitness information and offering advice in accordance with the present invention;

FIG. 4 is a block diagram of a mobile device of the system for integrating fitness information and offering advice in accordance with the present invention; and

FIG. 5 is a block diagram of a method for integrating fitness information and offering advice in accordance with the present invention.

### DETAILED DESCRIPTION OF PREFERRED EMBODIMENT

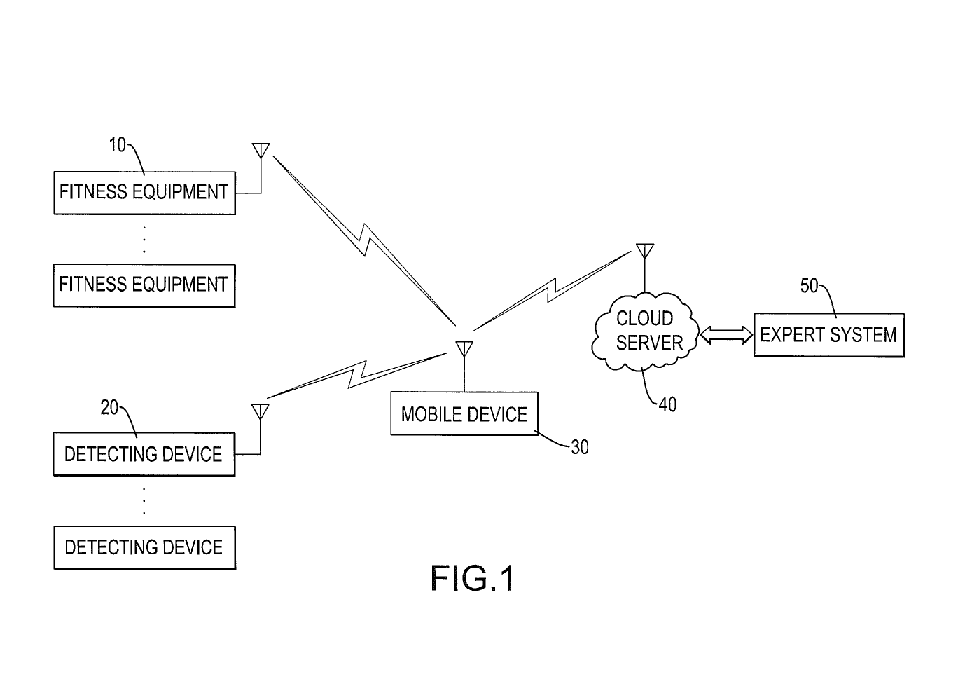

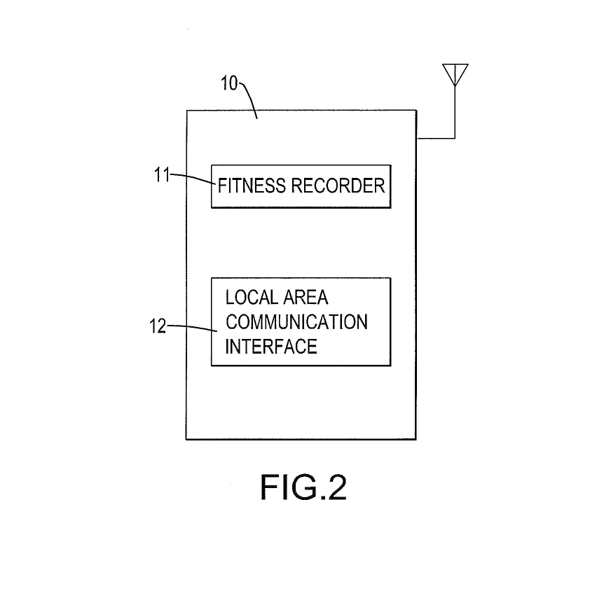

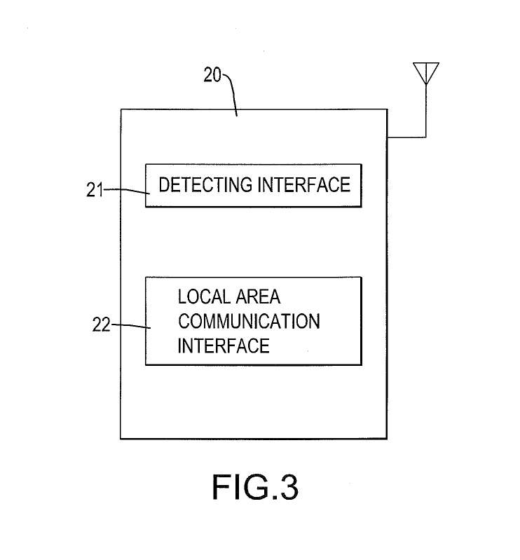

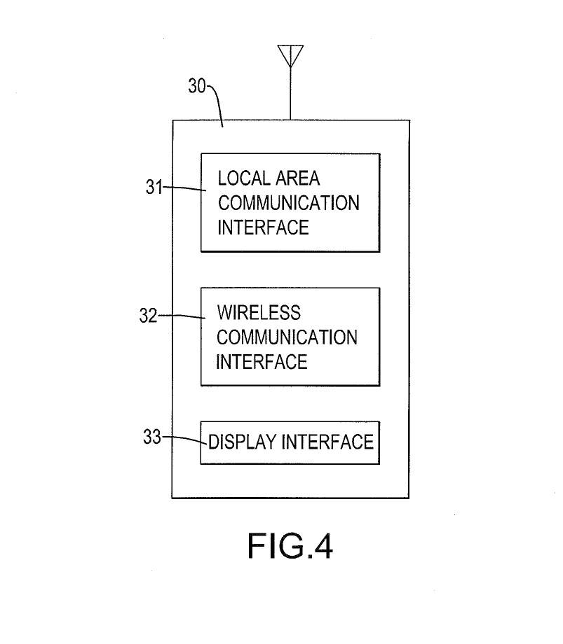

With reference to FIGS. 1-4, a system for integrating fitness information and offering advice in accordance with the present invention comprises multiple fitness equipments 10, multiple detecting devices 20, a mobile device 30, a cloud server 40 and an expert system 50.

The fitness equipments 10 can be chosen from a treadmill, an exercise bike, an ultrasound vibrator, a low-frequency electrotherapy device or a combination selected from the mentioned devices. Each fitness equipment 10 has a fitness recorder 11 and a local area communication interface. The fitness recorder 11 is instrumented in the fitness equipment 10 and is provided for storing fitness information of a user while the user operates the fitness equipment 10. The fitness information is recorded in the fitness recorder 11 and can be an exercise period, an amount of calories consumed or a duration of operating the fitness equipment 10. The local area communication interface 12 is instrumented in the fitness equipment 10 and is provided for transmitting the fitness information to the mobile device 30.

The detecting devices 20 can be chosen from a heart rate monitor, a fat monitor, a sphygmomanometer or a lactate detector. Each detecting device 20 has a detecting interface 21 and a local area communication interface 22. The detecting interface 21 is instrumented in the detecting device 20 and is provided for physically contacting the user and receiving physical information from the user. The physical information can be a heart rate, a body fat rate, a blood pressure or a lactate accumulation value. The local area communication interface 22 is instrumented in the detecting device 20, is connected with the detecting interface 21 and is provided for transmitting the physical information to the mobile device 30. Preferably, the multiple detecting devices 20 are respectively integrated into the multiple fitness equipments 10. Each detecting device 20 and the corresponding fitness equipment 10 share the local area communication interface 22. When the user operates the fitness equipment 10, the fitness recorder 11 records the fitness information of the user and the corresponding detecting device 20 simultaneously detects the physical information of the user. The shared local area communication interface 22 transmits the physical and fitness information to the mobile device 30.

The mobile device 30 can be a mobile phone or a communication device in watch style for connecting the fitness equipments 10 and the detecting devices 20. The mobile device 30 has a local area communication interface 31, a wireless communication interface 32 and a display interface 33. The local area communication interface 31 is instrumented in the mobile device 30 and is connected with the local area communication interface 12 of each fitness equipment 10 and the local area communication interface 22 of each detecting device 20 through a local area network protocol to receive the physical and fitness information. The local area communication interface 31 can be a wire communication interface, such as universal serial bus, or a local area communication protocol, such as Wi-Fi, Bluetooth, or infrared transmission interface. The wireless communication interface 32 is connected with the local area communication interface 31. The mobile device 30 is able to store the physical and fitness information and transmit the physical and fitness information to the cloud server 40 through the wireless communication interface 32. The display interface 33 is connected with the wireless communication interface 32 and is provided for presenting information received from the cloud server 40. Preferably, the display interface 33 can be a liquid crystal display or an electronic paper.

The cloud server 40 is connected to the mobile device 30 through a wireless communication protocol and transmits the physical and fitness information to the expert system 50. Preferably, the wireless communication protocol can be transmitted broadly through various base stations, such as Global System for Mobile Communications (GSM), General Packet Radio Service (GPRS) or Universal Mobile Telecommunications System (UMTS). The user may establish a personal condition data on the cloud server 40, such as weight, height or age. The cloud server 40 transmits the personal condition data, the physical and fitness information to the expert system 50.

The expert system 50 is connected with the cloud server 40 and receives the physical and fitness information from the cloud server 40. The expert system 50 has a knowledge base and an inference engine. The knowledge base stores various pre-established data. Based on the knowledge base, the inference engine concludes all composite conditions of the user, such as age, height, weight, a cumulative period of exercise, and the physical and fitness information, to determine advice information and transmit the advice information to the mobile device 30 through the cloud server 40.

With reference to FIG. 1, when the user operates one of the fitness equipments 10, the fitness recorder 11 of the fitness equipment 10 collects an exercise procedure and an exercise condition of the user to be the fitness information. The fitness information is transmitted to the local area communication interface 31 of the mobile device 30 through the local area communication interface 12 of the fitness equipment 10. Similarly, when the user operates one of the detecting devices 20, the detecting interface 21 contacts the skin of the user to detect the physical information of the user. The physical information is transmitted to the local area communication interface 31 of the mobile device 30 through the local area communication interface 22 of the detecting devices 20. If the detecting device 20 is integrated into the fitness equipment 10, the user actuates the detecting device 20 while the user operates the fitness equipment 10 to transmit the physical and fitness information through the shared local area communication interface. The mobile device 30 receives, stores and transmits the physical and fitness information to the cloud server 40. The expert system 50 receives the physical and fitness information from the cloud server 40 and determines the advice information based on a present condition of the user. The advice information is transmitted to the mobile device 30 and is displayed on the display interface 33. For example, when the user's lactate overly accumulates, the expert system 50 will advise the user to use the low-frequency electrotherapy device to decrease the lactate. The user can take the advice information to determine the next step of training.

When the user continues a following round of exercise, the fitness equipment 10 and the detecting device 20 will transmit new physical and fitness information to the expert system 50 through the mobile device 30 and the cloud server 40. The expert system 50 will determine a new advice based on the new physical and fitness information. During this sequence, the health and physical condition can be improved to a best result.

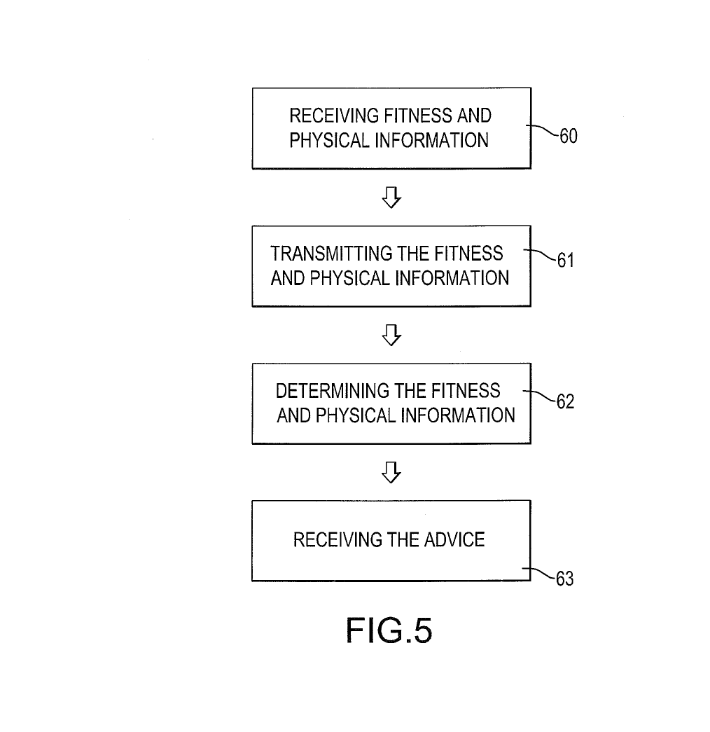

With reference to FIG. 5, a method for integrating fitness information and offering advice in accordance with the present invention comprises: receiving fitness and physical information 60, transmitting the fitness and physical information 61, determining the fitness and physical information 62, and receiving the advice 63.

Receiving fitness and physical information 60: actuating a mobile device 30 to receive the fitness information from multiple fitness equipments 10 and receive the physical information from multiple detecting devices 20 through a local area communication interface 31.

Transmitting the fitness and physical information 61: actuating a wireless communication interface 32 of the mobile device 30 to transmit the fitness and physical information to a cloud server 40 which is connected to an expert system 50.

Determining the fitness and physical information 62: utilizing the expert system 50 to determine advice information based on the fitness and physical information and transmit the advice information to the cloud server 40.

Receiving the advice 63: actuating the wireless communication interface 32 of the mobile device 30 to receive the advice information from the cloud server 40 and displaying the advice information on a display interface of the mobile device 30.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A system for integrating fitness information and offering advice comprising:
multiple fitness equipments, each fitness equipment having
a fitness recorder having a capability of storing fitness information from a user while the user operates the fitness equipment; and
a local area communication interface connected to the fitness recorder and having a capability of transmitting the fitness information;
multiple detecting devices, each detecting device having
a detecting interface having a capability of contacting the user and receiving physical information from the user;
a local area communication interface connected with the detecting interface and having a capability of transmitting the physical information;
a mobile device connected with the fitness equipments and the detecting devices and having
a local area communication interface having a capability of connecting with the local area communication interfaces of the fitness equipments and the local area communication interfaces of the detecting devices through a local area network protocol to receive the fitness information and the physical information;
a wireless communication interface connected with the local area communication of the mobile device and having a capability of transmitting the fitness information and the physical information; and
a display interface connected with the wireless communication interface and having a capability of presenting advice information;
a cloud server connected with the wireless communication interface of the mobile device through a wireless communication protocol to receive the fitness information and the physical information; and
an expert system connected with the cloud server, receiving the fitness information and the physical information from the cloud server, determining the advice information based on the fitness information and the physical information, and transmitting the advice information to the mobile device through the cloud server.

2. The system as claimed in claim 1, wherein the multiple detecting devices are respectively integrated into the multiple fitness equipments, and each detecting device and the corresponding fitness equipment share the local area communication interface.

3. The system as claimed in claim 1, wherein the fitness equipments are chosen from a group consisting of a treadmill, an exercise bike, an ultrasound vibrator and a low-frequency electrotherapy device.

4. The system as claimed in claim 1, wherein the detecting devices are chosen from a group consisting of a heart rate monitor, a fat monitor, a sphygmomanometer and a lactate detector.

5. A method for integrating fitness information and offering advice comprising:
receiving fitness and physical information: actuating a mobile device to receive the fitness information from multiple fitness equipments and receive the physical information from the multiple detecting devices through a local area communication interface;
transmitting the fitness and physical information: actuating a wireless communication interface of the mobile device to transmit the fitness and physical information to a cloud server which is connected to an expert system;
determining the fitness and physical information: utilizing the expert system to determine advice information based on the fitness and physical information and transmit the advice information to the cloud server; and
receiving the advice: actuating the wireless communication interface of the mobile device to receive the advice information from the cloud server and displaying the advice information on a display interface of the mobile device.
